(19) United States
(12) Patent Application Publication
(10) Pub. No.: US 2024/0275627 A1
(43) Pub. Date: Aug. 15, 2024

(54) CONTROL DEVICE, CONTROL METHOD, CONTROL PROGRAM, AND SIGNAL FORWARDING CONTROL SYSTEM

(71) Applicant: NIPPON TELEGRAPH AND TELEPHONE CORPORATION, Tokyo (JP)

(72) Inventors: Takamitsu TOCHINO, Musashino-shi, Tokyo (JP); Yoshihito SAKAI, Musashino-shi, Tokyo (JP); Hirotaka UJIKAWA, Musashino-shi, Tokyo (JP)

(21) Appl. No.: 18/568,692

(22) PCT Filed: Jun. 11, 2021
(86) PCT No.: PCT/JP2021/022354

§ 371 Date: Dec. 8, 2023

(51) Int. Cl. H04L 12/28; H04L 43/087

(52) U.S. Cl. CPC H04L 12/28; H04L 43/087

(57) ABSTRACT

The signal transfer device receives a periodically transmitted periodic signal and transfers the periodic signal in a reserved window. A control device that controls a signal transfer device includes a storage device configured to store reference information indicating a transmission amount and a transmission period of the periodic signals of each of a plurality of flows received by the signal transfer device. The control device further includes a processor that executes window setting processing based on the reference information. In the window setting processing, the control device sets a schedule of a plurality of windows for each of the plurality of flows in the signal transfer device based on the reference information, and instructs the signal transfer device to reserve the plurality of windows according to the schedule.

### TECHNICAL FIELD

The present disclosure relates to a technology for controlling a signal transfer device that transfers a periodic signal in a reserved window.

### BACKGROUND ART

Non Patent Literature 1 and Non Patent Literature 2 disclose time-sensitive networking (TSN) that ensures real-time properties.

A time aware shaper (TAS) is one technology for realizing a low-delay network. In particular, the TAS realizes a low delay of a priority signal periodically transmitted from the transmission device. Specifically, in a signal transfer device such as a switch in a network, a window (transfer period, timeslot) for transferring a priority signal is reserved (secured) in advance. In the reserved window, the gate of the queue for the priority signal is opened and the priority signal is transferred, while the gate of the queue for the other signal is closed and the other signal is kept waiting without being transferred. As a result, the queuing delay of the priority signal is suppressed.

### CITATION LIST

### Non Patent Literature

Non Patent Literature 1: “IEEE Standard for Local and metropolitan area networks—Time-Sensitive Networking for Fronthaul,” IEEE Std 802.1CM, May 7, 2018 Non Patent Literature 2: J. Farkas, “Introduction to IEEE802.1 Focus on the Time-Sensitive Networking Task Group,” May 15, 2017 (https://www.ieee802.org/1/files/public/docs2017/tsn-farkas-intro-0517-v01.pdf)

### SUMMARY OF INVENTION

### Technical Problem

As described above, the TAS handles periodically transmitted signals (hereinafter referred to as “periodic signals”). Here, a case where the signal transfer device receives periodic signals of a plurality of flows is considered. In the signal transfer device, a plurality of windows for each of a plurality of flows are reserved in advance. At this time, a technology through which (setting) a plurality of windows can be flexibly reserved for each of a plurality of flows is desired.

For example, when the transmission periods of the periodic signals are different among the plurality of flows, there is a possibility of a plurality of windows for each of the plurality of flows overlapping at the same time. When the overlapping of the windows occurs, in the overlapping period, only the periodic signal of one flow is transferred, and the periodic signals of the other flows are not transferred. As a result, at least some of the periodic signals remain queued until the next window. Therefore, jitter for the window period occurs.

One object of the present disclosure is to provide a technology for controlling a signal transfer device that transfers a periodic signal in a reserved window, and through which a plurality of windows can be flexibly reserved for each of a plurality of flows.

### Solution to Problem

A first aspect relates to a control device that controls a signal transfer device. The signal transfer device receives a periodically transmitted periodic signal and transfers the periodic signal in a reserved window.

The control device includes
a storage device configured to store reference information indicating a transmission amount and a transmission period of the periodic signals of each of a plurality of flows received by the signal transfer device; and
a processor configured to execute window setting processing of setting a schedule of a plurality of windows for each of the plurality of flows in the signal transfer device based on the reference information and instructing the signal transfer device to reserve the plurality of windows according to the schedule.

A second aspect relates to a control method for controlling a signal transfer device. The signal transfer device receives a periodically transmitted periodic signal and transfers the periodic signal in a reserved window.

The control method includes
processing of acquiring reference information indicating a transmission amount and a transmission period of the periodic signals of each of a plurality of flows received by the signal transfer device; and
window setting processing of setting a schedule of a plurality of windows for each of the plurality of flows in the signal transfer device based on the reference information and instructing the signal transfer device to reserve the plurality of windows according to the schedule.

A third aspect relates to a control program executed by a processor that controls a signal transfer device. The signal transfer device receives a periodically transmitted periodic signal and transfers the periodic signal in a reserved window.

The control program causes the processor to execute
processing of acquiring reference information indicating a transmission amount and a transmission period of the periodic signals of each of a plurality of flows received by the signal transfer device, and
window setting processing of setting a schedule of a plurality of windows for each of the plurality of flows in the signal transfer device based on the reference information and instructing the signal transfer device to reserve the plurality of windows according to the schedule.

A fourth aspect relates to a signal transfer control system.

A signal transfer control system includes:
a signal transfer device that receives a periodically transmitted periodic signal and transfers the periodic signal in a reserved window; and
a control device that controls the signal transfer device.

The control device includes
a storage device configured to store reference information indicating a transmission amount and a transmission period of the periodic signals of each of a plurality of flows received by the signal transfer device; and
a processor configured to execute window setting processing of setting a schedule of a plurality of windows for each of the plurality of flows in the signal transfer device based on the reference information and instructing the signal transfer device to reserve the plurality of windows according to the schedule.

### Advantageous Effects of Invention

According to the present disclosure, the window setting processing is executed based on the reference information regarding the periodic signal of each flow received by the signal transfer device. More specifically, a schedule of a plurality of windows for each of a plurality of flows in the signal transfer device is set based on the reference information. The signal transfer device is instructed to reserve a plurality of windows according to the set schedule. As a result, it is possible to flexibly reserve (set) a plurality of windows for each of a plurality of flows in the signal transfer device.

### BRIEF DESCRIPTION OF DRAWINGS

FIG. 1 is a block diagram schematically illustrating a configuration of a signal transfer control system according to an embodiment of the present disclosure.

FIG. 2 is a block diagram illustrating a configuration example of a signal transfer device according to the embodiment of the present disclosure.

FIG. 3 is a block diagram illustrating a configuration example of a control device according to the embodiment of the present disclosure.

FIG. 4 is a conceptual diagram for explaining a problem.

FIG. 5 is a conceptual diagram for explaining an example of window adjustment processing according to the embodiment of the present disclosure.

FIG. 6 is a conceptual diagram for explaining another example of the window adjustment processing according to the embodiment of the present disclosure.

FIG. 7 is a flowchart illustrating an example of the window setting processing according to the embodiment of the present disclosure.

### DESCRIPTION OF EMBODIMENTS

An embodiment of the present disclosure will be described with reference to the accompanying drawings.

### 1. Signal Transfer Control System

### 1-1. Overview

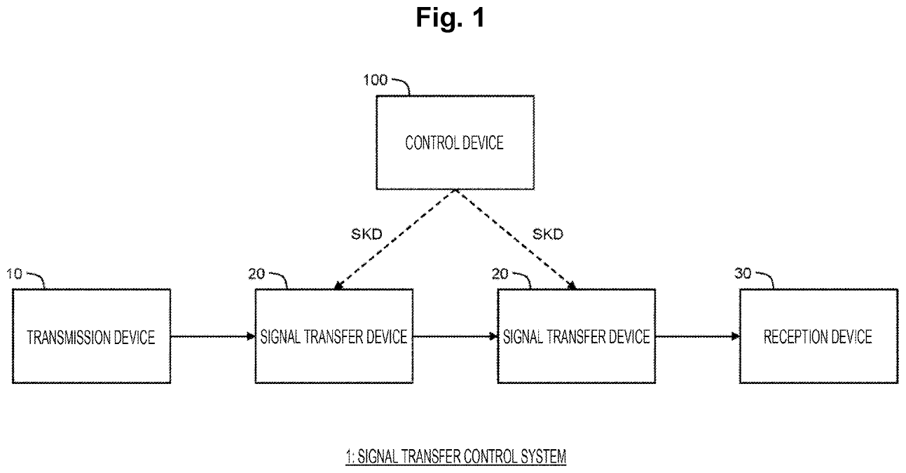

FIG. 1 is a block diagram schematically illustrating a configuration of a signal transfer control system 1 according to the present embodiment. The signal transfer control system 1 includes a transmission device 10, a signal transfer device 20, and a reception device 30. The transmission device 10 and the reception device 30 are connected via at least one signal transfer device 20, thereby constituting a communication network. A plurality of signal transfer devices 20 may be interposed between the transmission device 10 and the reception device 30.

The transmission device 10 transmits a signal to the reception device 30 and generates traffic (flow). The transmission device 10 is, for example, a user terminal. The signal transfer device 20 receives a signal transmitted from the transmission device 10 and transfers the received signal to a device at the next stage. The signal transfer device 20 is, for example, a switch. The reception device 30 receives a signal transmitted from the transmission device 10 and transferred by the signal transfer device 20.

The signal transmitted from the transmission device 10 includes a periodically transmitted “periodic signal.” The signal transfer device 20 corresponds to a time aware shaper (TAS) that realizes a low delay of the periodic signal. Specifically, in the signal transfer device 20, a window (transfer period, timeslot) for transferring a periodic signal is reserved (secured) in advance. In the reserved window, the gate of the queue for the periodic signal is opened and the periodic signal is transferred, while the gate of the queue for the other signal is closed and the other signal is kept waiting without being transferred. As a result, the queuing delay of the periodic signal is suppressed.

The signal transfer control system 1 according to the present embodiment further includes a control device 100. The control device 100 is communicably connected to each signal transfer device 20, and is configured to be able to control each signal transfer device 20. In particular, the control device 100 is configured to be able to flexibly reserve a window in each signal transfer device 20. In other words, the control device 100 is configured to be able to variably set the window in each signal transfer device 20.

More specifically, the control device 100 sets a schedule of a window in the signal transfer device 20 and transmits “schedule setting information SKD” to the signal transfer device 20. The schedule setting information SKD is information indicating a schedule of the set window and instructing the signal transfer device 20 to reserve (set) the window according to the schedule. The signal transfer device 20 receives the schedule setting information SKD transmitted from the control device 100 and reserves (sets) the window according to the schedule specified by the schedule setting information SKD. That is, the control device 100 flexibly controls the window setting in the signal transfer device 20 by transmitting the schedule setting information SKD to the signal transfer device 20.

It is also conceivable that the signal transfer device 20 receives periodic signals of each of a plurality of flows (traffic). In this case, the control device 100 sets a schedule of a plurality of windows for each of a plurality of flows in the signal transfer device 20. Then, the control device 100 transmits schedule setting information SKD indicating the set schedules of the plurality of windows to the signal transfer device 20. The signal transfer device 20 receives the schedule setting information SKD transmitted from the control device 100, and reserves (sets) a plurality of windows for each of the plurality of flows according to the schedule specified by the schedule setting information SKD. In this manner, it is possible to flexibly reserve (set) a plurality of windows for each of a plurality of flows in the signal transfer device 20.

### 1-2. Configuration Example of Signal Transfer Device

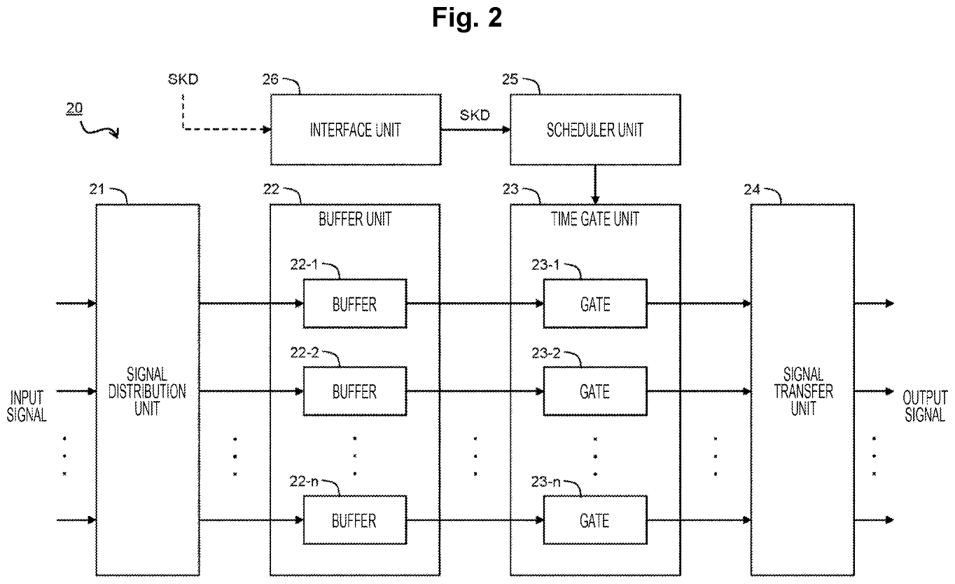

FIG. 2 is a block diagram illustrating a configuration example of the signal transfer device 20 according to the present embodiment. The signal transfer device 20 includes a signal distribution unit 21, a buffer unit 22, a time gate unit 23, a signal transfer unit 24, a scheduler unit 25, and an interface unit 26.

The signal distribution unit 21 receives an input signal input to the signal transfer device 20. The signal distribution unit 21 distributes the input signal for each priority of the flow, and outputs the input signal to the buffer unit 22 for each priority. The priority of the flow is defined by, for example, a class of service (COS) value in the header. The input signal also includes a periodic signal periodically transmitted from the transmission device 10. Typically, the periodic signal is a priority signal with a high priority.

The buffer unit 22 has different buffers (queues) for each priority of a flow. That is, the buffer unit 22 includes a plurality of buffers 22-1 to 22-n provided for each of a plurality of priorities. Herein, n is an integer of 2 or more. The input signal of each flow is stored in a buffer associated with the priority of the flow.

The time gate unit 23 is provided to control signal transmission for each buffer (priority). More specifically, the time gate unit 23 includes a plurality of gates 23-1 to 23-n provided for each of the plurality of priorities. The plurality of gates 23-1 to 23-n are connected to the plurality of buffers 22-1 to 22-n, respectively. When the gate 23-i (i=1 to n) is closed, no signal is output from the buffer 22-i. When the gate 23-i is opened, the signal stored in the buffer 22-i is transmitted to the signal transfer unit 24.

The signal transfer unit 24 receives a signal from the buffer unit 22 via the time gate unit 23. The signal transfer unit 24 outputs the received signal to the device at the next stage.

The scheduler unit 25 controls opening and closing of each of the gates 23-1 to 23-n of the time gate unit 23 to control signal transfer by the signal transfer device 20. In addition, the scheduler unit 25 supports the TAS and reserves a window (transfer period, timeslot) for transferring a periodic signal. In the reserved window, the scheduler unit 25 opens only the gate 23-p corresponding to the buffer 22-p in which the periodic signal is stored and closes the other gates.

According to the present embodiment, the control device 100 may determine a schedule of a window for transferring a periodic signal. In this case, the control device 100 transmits the schedule setting information SKD to the signal transfer device 20. The interface unit 26 of the signal transfer device 20 communicates with the control device 100 and receives the schedule setting information SKD from the control device 100. The interface unit 26 transfers the received schedule setting information SKD to the scheduler unit 25. The scheduler unit 25 reserves (sets) a window according to the schedule specified by the schedule setting information SKD.

### 1-3. Configuration Example of Control Device

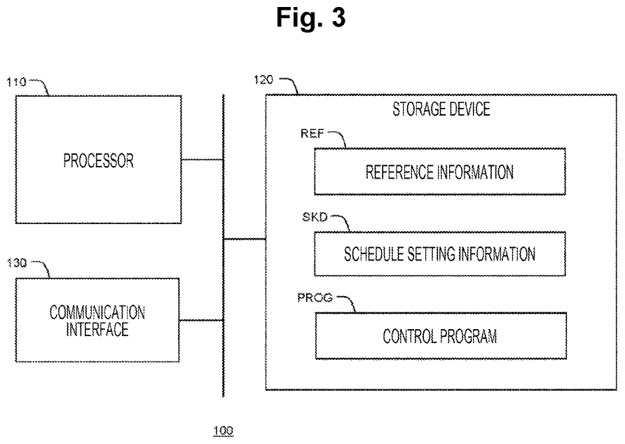

FIG. 3 is a block diagram illustrating a configuration example of a control device 100 according to the present embodiment. The control device 100 includes one or more processors 110 (hereinafter simply referred to as “processor 110”), one or more storage devices 120 (hereinafter simply referred to as “storage device 120”), and a communication interface 130.

The processor 110 performs various types of information processing. For example, the processor 110 includes a central processing unit (CPU). The storage device 120 stores various types of information necessary for processing by the processor 110. Examples of the storage device 120 include a volatile memory, a non-volatile memory, a hard disk drive (HDD), a solid state drive (SSD), and the like. The communication interface 130 communicates with each signal transfer device 20.

A control program PROG is a computer program executed by the processor 110. The processor 110 executes the control program PROG to realize the functions of the processor 110 (control device 100). The control program PROG is stored in the storage device 120. The control program PROG may be recorded in a computer-readable recording medium. The control program PROG may be provided to the control device 100 via a network.

The processor 110 may be realized by using hardware such as an application specific integrated circuit (ASIC), a programmable logic device (PLD), or a field programmable gate array (FPGA).

Reference information REF indicates a transmission amount, a transmission period, a transmission phase, an initial transmission time, and the like of the periodic signal of each flow received by the signal transfer device 20. For example, the reference information REF is collected from the transmission device 10 or the signal transfer device 20 that handles the periodic signal of each flow. As another example, the reference information REF may be provided in advance from the network administrator to the control device 100. The processor 110 acquires the reference information REF. The acquired reference information REF is stored in the storage device 120.

The processor 110 executes “window setting processing” based on the reference information REF. More specifically, the processor 110 sets the schedule of the window for each flow in the signal transfer device 20 based on the transmission amount, the transmission period, and the like of the periodic signal of each flow indicated by the reference information REF. When the signal transfer device 20 receives periodic signals of a plurality of flows, the processor 110 sets a schedule of a plurality of windows for each of the plurality of flows. The priorities of the plurality of flows may be different. Then, the processor 110 generates the schedule setting information SKD reflecting the schedule setting result. More specifically, the schedule setting information SKD is information indicating a schedule of the set window and instructing the signal transfer device 20 to reserve (set) the window according to the schedule. The schedule setting information SKD is stored in the storage device 120. The processor 110 transmits the generated schedule setting information SKD to the signal transfer device 20 via the communication interface 130.

### 1-4. Effects

As described above, according to the present embodiment, the control device 100 executes the window setting processing based on the reference information REF related to the periodic signals of each flow received by the signal transfer device 20. More specifically, the control device 100 sets a schedule of the plurality of windows for each of the plurality of flows in the signal transfer device 20 based on the reference information REF. Then, the control device 100 instructs the signal transfer device 20 to reserve a plurality of windows according to the set schedule. As a result, it is possible to flexibly reserve (set) the plurality of windows for each of the plurality of flows in the signal transfer device 20.

### 2. Example of Window Setting Processing

### 2-1. Overview

Hereinafter, as an example, a case where the transmission period of the periodic signal is different among a plurality of flows will be considered.

When the transmission period of the periodic signal is different among the plurality of flows, there is a possibility of a plurality of windows for each of the plurality of flows overlapping at the same time. When the overlapping of the windows occurs, in the overlapping period, only the periodic signal of one flow is transferred, and the periodic signals of the other flows are not transferred. As a result, at least some of the periodic signals remain queued until the next window. Therefore, jitter for the window period occurs.

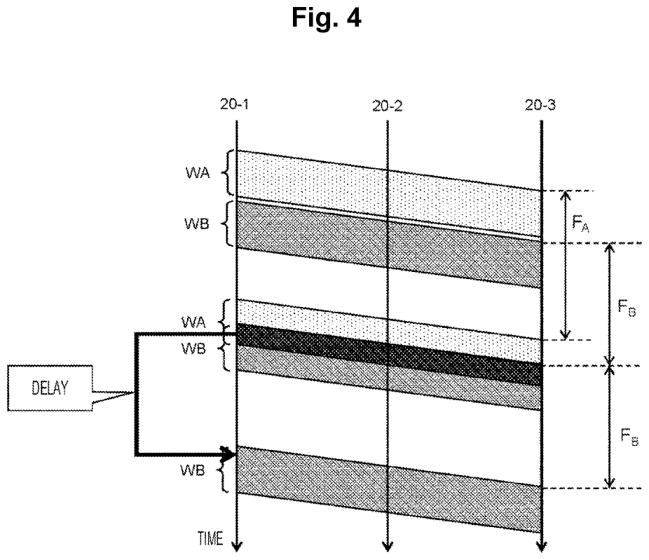

FIG. 4 is a conceptual diagram for explaining the above-described problem. Here, two types of a first flow A and a second flow B will be considered. It is assumed that the priority of the first flow A is higher than the priority of the second flow B. The periodic signals of the first flow A and the second flow B are transferred in order of the signal transfer devices 20-1, 20-2, and 20-3.

As an example, the signal transfer device 20-1 will be considered. A first window WA is a window set to transfer the periodic signal of the first flow A. A first transmission period F_{A} is a transmission period of a periodic signal of the first flow A. A first transmission time L_{A} is a time required for transmitting a transmission amount per transmission of the periodic signal of the first flow A. A first initial transmission time t0_{A} is an initial transmission time of the periodic signal of the first flow A in the signal transfer device 20-1. The default setting of the first window WA in the signal transfer device 20-1 is as follows. Furthermore, the number in parentheses represents an identification number of the period.

<Default setting of first window WA>
WA (0) = t0_{A} to t0_{A} + L_{A}
WA (1) = t0_{A} + F_{A} to t0_{A} + F_{A} + L_{A}
WA (2) = t0_{A} + 2 × F_{A} to t0_{A} + 2 × F_{A} + L_{A}
. . .

Similarly, a second window WB is a window set to transfer the periodic signal of the second flow B. A second transmission period FB is a transmission period of a periodic signal of the second flow B. A second transmission time L_{B} is a time required for transmitting a transmission amount per transmission of the periodic signal of the second flow B. A second initial transmission time t0_{B} is an initial transmission time of the periodic signal of the second flow B in the signal transfer device 20-1. The default setting of the second window WB in the signal transfer device 20-1 is as follows.

<Default setting of second window WB>
WB (0) = t0_{B} to t0_{B} + L_{B}
WB (1) = t0_{B} + F_{B} to t0_{B} + F_{B} + L_{B}
WB (2) = t0_{B} + 2 × F_{B} to t0_{B} + 2 × F_{B} + L_{B}
. . .

The default setting of the first window WA in the signal transfer devices 20-2 and 20-3 is shifted from the default setting of the first window WA in the signal transfer device 20-1 by the transmission delay. Similarly, the default setting of the second window WB in the signal transfer devices 20-2 and 20-3 is shifted from the default setting of the second window WB in the signal transfer device 20-1 by the transmission delay.

The first transmission period F_{A} and the second transmission period FB are different from each other. Therefore, there is a possibility of the first window WA(j) of a certain period j and the second window WB(k) of a certain period k overlapping. In the example illustrated in FIG. 4, the second half part of the first window WA(j) of the certain period j and the first half part of the second window WB(k) of the certain period k overlap. In the overlap period, only the periodic signal of the first flow A is transferred, and the periodic signal of the second flow B is not transferred. As a result, some of the periodic signals of the second flow B of the period k remains queued until the next second window WB(k+1). As a result, jitter for the second transmission period FB occurs with respect to the periodic signal of the second flow B.

In order to suppress the occurrence of such jitter, the control device 100 (processor 110) according to the present embodiment appropriately executes “window adjustment processing.”

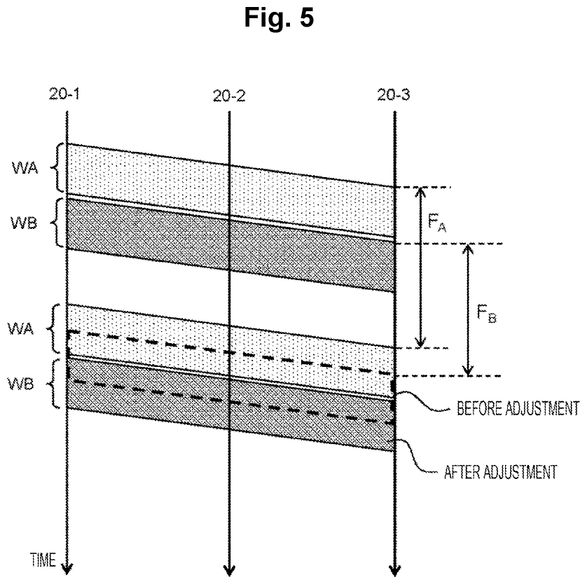

FIG. 5 is a conceptual diagram for explaining the window adjustment processing in the situation illustrated in FIG. 4. The processor 110 moves (shifts) at least one of the first window WA(j) and the second window WB(k) such that the first window WA(j) and the second window WB(k) do not overlap. In the example illustrated in FIG. 5, the processor 110 moves the second window WB(k) for the second flow B having a relatively low priority to be later than the first window WA(j). For example, when the overlapping time of the default setting of the first window WA(j) and the second window WB(k) is Δt, the processor 110 moves (shifts) the second window WB(k) to the back from the default setting by the overlapping time Δt. As a result, the overlapping between the first window WA(j) and the second window WB(k) is eliminated. As a result, jitter related to transfer of the periodic signal of the second flow B is suppressed.

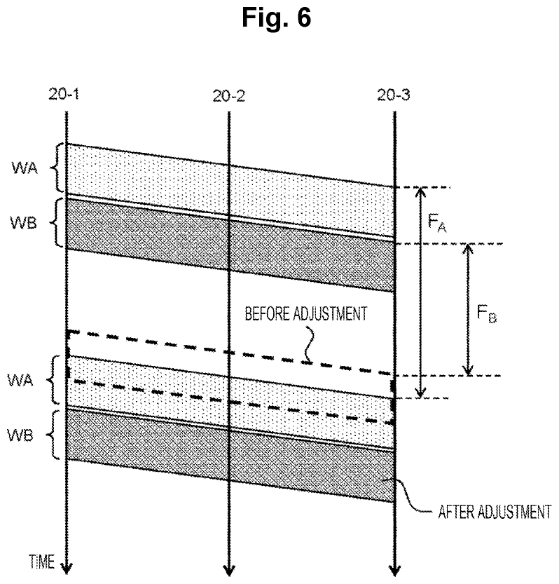

FIG. 6 is a conceptual diagram for explaining another example of the window adjustment processing. In the default setting, the second half part of the second window WB(k) of the certain period k and the first half part of the first window WA(j) of the certain period j overlap. Similarly in this case, the processor 110 moves the second window WB(k) for the second flow B having a relatively low priority to be later than the first window WA(j). As a result, the overlapping between the first window WA(j) and the second window WB(k) is eliminated, and the jitter is suppressed.

General description is as follows. In the window setting processing, the processor 110 acquires default settings of the plurality of windows for each of the plurality of flows based on the reference information REF. In a case where the default settings of the plurality of windows overlap each other, the processor 110 executes the window adjustment processing of adjusting at least some of the plurality of windows to eliminate the overlapping. Then, the processor 110 transmits the schedule setting information SKD reflecting the adjusted window setting to each signal transfer device 20. That is, the processor 110 appropriately executes the window adjustment processing during the window setting processing to set the plurality of windows for each of the plurality of flows not to overlap each other. As a result, jitter related to transfer of the periodic signal is suppressed.

### 2-2. Example of Processing Flow

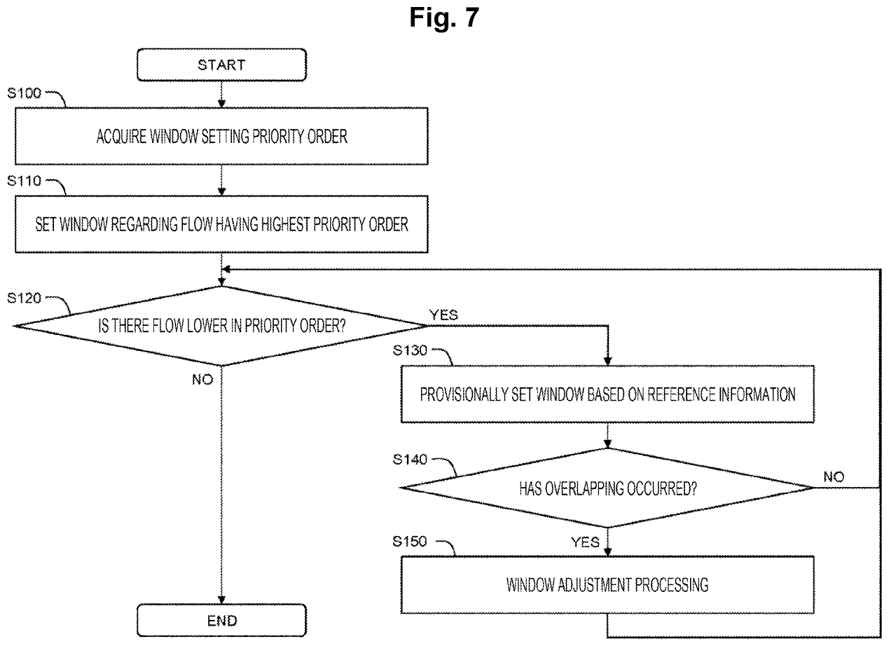

FIG. 7 is a flowchart illustrating an example of the window setting processing according to the present embodiment.

In step S100, the processor 110 acquires “window setting priority order” of the plurality of flows. The window setting priority order is a priority order of securing a window. Typically, the priority of each of the plurality of flows is directly used as the window setting priority order. For example, in the example illustrated in FIGS. 4 to 6, the window setting priority order of the first flow A is higher than the window setting priority order of the second flow B. In other words, the window setting priority order of the second flow B is lower than the window setting priority order of the first flow A.

In step S110, the processor 110 sets the flow (for example, the first flow A) having the highest window setting priority order as the target flow. Then, the processor 110 sets (secures) a window related to the target flow based on the reference information REF. The window here is a window set by default.

In step S120, the processor 110 determines whether or not there is a flow lower in the window setting priority order. In a case where there is no flow lower in the window setting priority order (step S120; No), the processing in this cycle ends. On the other hand, in a case where there is a flow lower in the window setting priority order (step S120; Yes), the processor 110 sets the flow as the target flow. Then, the processing proceeds to step S130.

In step S130, the processor 110 provisionally sets a window related to the target flow (for example, the second flow B) based on the reference information REF. The window here is a window set by default.

In subsequent step S140, the processor 110 determines whether or not the window provisionally set in step S130 overlaps the window having the already set higher priority. In a case where the provisionally set window overlaps the window having the already set higher priority (step S140; Yes), the processing proceeds to step S150. Otherwise (step S140; No), the processing returns to step S120.

In step S150, the processor 110 executes the above-described window adjustment processing (refer to FIGS. 5 and 6). That is, the processor 110 moves the provisionally set window to be later than the window higher in the priority to eliminate the overlapping. Thereafter, the processing returns to step S120.

As described above, according to the processing flow illustrated in FIG. 7, the processor 110 more preferentially secures a window for a flow higher in the window setting priority order. When the overlapping of the windows occurs, the processor 110 performs window adjustment processing to eliminate the overlapping. As a result, the plurality of windows for each of the plurality of flows can be set not to overlap each other, and jitter can be suppressed.

### 2-3. Modification Example

The processor 110 may repeatedly execute the window setting processing. For example, the processor 110 may periodically execute the window setting processing.

Each time the window setting processing is performed, the processor 110 may change the setting of the window setting priority order for a plurality of flows. For example, in certain window setting processing, the processor 110 sets the window setting priority order of the first flow A to be higher than the window setting priority order of the second flow B. Then, in the next window setting processing, the processor 110 sets the window setting priority order of the second flow B to be higher than the window setting priority order of the first flow A.

The processor 110 may execute window setting processing based on preset allowable jitter. For example, in a case where the allowable jitter is set for each of the plurality of flows, the processor 110 sets the window setting priority order to be higher as the allowable jitter is smaller (stricter). For example, in a case where the allowable jitter of the first flow A is 100 μs and the allowable jitter of the second flow B is 200 μs, the window setting priority order of the first flow A is set to be higher than the window setting priority order of the second flow B.

### REFERENCE SIGNS LIST

1 Signal transfer control system
10 Transmission device
20 Signal transfer device
21 Signal distribution unit
22 Buffer unit
22-1 to 22-n Buffer
23 Time gate unit
23-1 to 23-n Gate
24 Signal transfer unit
25 Scheduler unit
26 Interface unit
30 Reception device
100 Control device
110 Processor
120 Storage device
130 Communication interface
PROG Control program
REF Reference information
SKD Schedule setting information

1. A control device that controls a signal transfer device that receives a periodically transmitted periodic signal and transfers the periodic signal in a reserved window, the control device comprising:
a storage device configured to store reference information indicating a transmission amount and a transmission period of the periodic signals of each of a plurality of flows received by the signal transfer device; and
a processor configured to execute window setting processing of setting a schedule of a plurality of windows for each of the plurality of flows in the signal transfer device based on the reference information and instructing the signal transfer device to reserve the plurality of windows according to the schedule.

2. The control device according to claim 1, wherein
the transmission period of the periodic signal is different among the plurality of flows, and
in the window setting processing, the processor sets the plurality of windows for each of the plurality of flows not to overlap each other based on the reference information.

3. The control device according to claim 2, wherein,
in the window setting processing, the processor acquires a window setting priority order of the plurality of flows and more preferentially secures the window for a flow higher in the window setting priority order.

4. The control device according to claim 3, wherein
the plurality of flows include a first flow and a second flow lower in the window setting priority order than the first flow,
a first window is the window for transferring the periodic signal of the first flow,
a second window is the window for transferring the periodic signal of the second flow, and
the processor is further configured to
set the first window based on the reference information, and provisionally set the second window, and
when the provisionally set second window overlaps the first window, move the second window to be later than the first window to eliminate the overlapping.

5. The control device according to claim 3, wherein
the processor is configured to repeatedly execute the window setting processing, and change setting of the window setting priority order for the plurality of flows each time the window setting processing is performed.

6. A control method for controlling a signal transfer device that receives a periodically transmitted periodic signal and transfers the periodic signal in a reserved window, the control method comprising:
processing of acquiring reference information indicating a transmission amount and a transmission period of the periodic signals of each of a plurality of flows received by the signal transfer device; and
window setting processing of setting a schedule of a plurality of windows for each of the plurality of flows in the signal transfer device based on the reference information and instructing the signal transfer device to reserve the plurality of windows according to the schedule.

7. A non-transitory computer readable medium storing one or more instructions executed by a processor that controls a signal transfer device that receives a periodically transmitted periodic signal and transfers the periodic signal in a reserved window, the one or more instructions causing the processor to execute:
processing of acquiring reference information indicating a transmission amount and a transmission period of the periodic signals of each of a plurality of flows received by the signal transfer device, and
window setting processing of setting a schedule of a plurality of windows for each of the plurality of flows in the signal transfer device based on the reference information and instructing the signal transfer device to reserve the plurality of windows according to the schedule.

8. (canceled)
